(19) United States
(12) Patent Application Publication
(10) Pub. No.: US 2016/0002411 A1
(43) Pub. Date: Jan. 7, 2016

(54) IMPROVING THE CHEMICAL STABILITY OF MEMBRANES

(71) Applicant: BASF SE, Ludwigshafen (DE)

(72) Inventors: Edoardo MENOZZI, Wettingen (CH); Martin WEBER, Maikammer (DE); Martin HEIJNEN, Landsberg am Lech (DE)

(73) Assignee: BASF SE, Ludwigshafen (DE)

(21) Appl. No.: 14/770,684

(22) PCT Filed: Apr. 16, 2014
(86) PCT No.: PCT/EP2014/057791

§ 371 Date: Aug. 26, 2015

(30) Foreign Application Priority Data
Apr. 19, 2013 (EP) 13164510.3

(51) Int. Cl. C08G 77/458; B01D 69/06; B29C 67/20; B01D 65/06; B01D 67/00; C02F 1/44; B01D 71/80; B01D 69/08

(52) U.S. Cl. CPC C08G 77/458; B01D 71/80; B01D 69/06; B01D 69/08; B01D 65/06; B01D 67/0009; C02F 1/44; B29C 67/202; B01D 2325/28; B01D 2325/30; B01D 2325/022; B29K 2083/00

(57) ABSTRACT

Polymer membranes, especially as used for water filtration processes, are effectively stabilized against detrimental effects of acids, bases and/or oxidizing agents commonly used for chemically enhanced backwash by incorporation of an oligo- or polyurethane of the formula (I) wherein k and n independently are numbers from 1 to 100, m is from the range 0-100, (X) is a block of formula (II) and (Y) is a block of the formula (III), (A) is a residue of an aliphatic or aromatic diisocyanate linker, (B) is a residue of a linear oligo- or polysiloxane containing alkanol end groups, and optionally further containing one or more aliphatic ether moieties, and (C) is an aromatic oligo- or polysulfone block; or a mixture of such oligo- or polyurethanes.

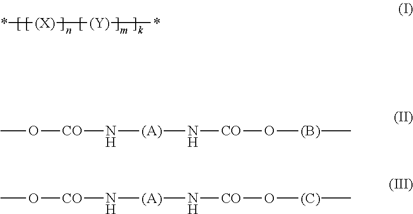

The invention relates to the use of certain polyurethane block copolymers based on poly siloxane(tensides), with or without anchoring units, for improving a membrane's chemical resistance, especially the one of water filtration membranes as used e.g. for micro- and ultrafiltration, nanofiltration or reverse osmosis. The invention further relates to a filtration process which includes chemical cleanings, which process uses a filtration membrane comprising aforesaid polyurethane block copolymers.

The most common polymeric membranes for water filtration are based on cellulose acetate, polysulfone (PSU), polyethersulfone (PESU), and poly(vinyldifluoride) (PVDF), and cross linked (semi)aromatic polyamide materials. WO11/110441 discloses a number of filtration membranes comprising siloxane-urethane block copolymers as anti-adhesion additive for the prevention of biofouling. For the regular cleaning of filter units, membranes are often contacted with oxidizing solutions; such steps are also recalled as chemical backwash, disinfection or bleaching. Such solutions commonly used as cleaner and disinfectant for filtration membranes in water applications (containing, for example, H₂O₂, ozone, peracetic acid, ClO₂, KMnO₄, Cl₂ gas dissolved in water) can cause changes in membrane properties. As a result, either the functional properties of the membranes gradually change, so the production can no longer meet requirements in terms of volume or quality, or the membranes simply breaks, and the system has to be shut down for maintenance causing loss in terms of money and clean water output. Damages known in the art to be caused by oxidizing agents include a drop of the membrane's mechanical properties, fiber embrittlement, degradation of transport properties.

It is known that degradation, which generates an embrittlement of the fiber, occurs by polymer chain scission caused by the hydroxyl radical (OH•) formed in the bleach solution. The lifetime of the fiber exposed to elemental chlorine depends on the total chlorine concentration of the solution and also on its pH, which drives the disproportioning into hypochlorous acid and hypochlorite ions, essential condition for the formation of hydroxyl radicals (see, for example, E. Gaudichet-Maurin, F. Thominette, Journal of Membrane Science 2006, 282, pag. 198-204).

Processes run in the drinking water industry subject membranes to a cleaning regime requiring 1 minute chlorine backwash typically after 30 to 60 minutes using 10 ppm of chlorine, and 15-30 minutes of chlorine backwash once a week using 400 ppm of chlorine at pH 12 (C. Regula et al., Separation and Purification Technology 103, p. 119-138 (2013)).

The problem of chemical degradation is pronounced in semipermeable membranes used for separation purposes like micro- and ultrafiltration or reverse osmosis. Membranes may be classified according to their pore dimension in most of the application profiles. For example, in water filtration applications micro- and ultrafiltration membranes (approximate pore diameter: 10-1000 nm) are used for wastewater treatment retaining organic and bioorganic material. Much smaller diameters are required in desalination applications (reverse osmosis; approximate pore diameter 1 nm) for retaining ions. In both applications, the ambient medium is an aqueous phase, where blockage may occur by deposition of inorganic and organic pollutants, soiling, adhesion of microorganisms and bio-film formation. In consequence, membranes used in such continuous filtration processes, especially on industrial scale, have to undergo regular cleaning cycles to remove blockages. For the regular cleaning of filter units, such membranes thus are often contacted with acids, bases and/or oxidizing solutions such as described above (chemically enhanced backwash), which impact their structure morphology. A further application is a continuous use of oxidizing agents, for example as a continuous feed chlorination such as commonly used for swimming pools or in process control.

It is essential to improve chemical stability and mechanical properties behavior of membranes. It has now been found that if such membranes are made by incorporating a certain type of hydrophobic/hydrophilic polyurethane siloxane block copolymer, such as those of WO11/110441, the composite membranes thus obtained exhibit extended resistance to cleaning operations using acid, base and especially oxidizing media such as bleach solutions. Improved chemical resistance is desirable as it extends the membrane's life time.

The present invention thus pertains to the use of an oligo- or polyurethane of the formula I

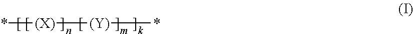

wherein k and n independently are numbers from 1 to 100,
m is from the range 0-100,
(X) is a block of formula

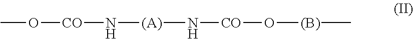

and (Y) is a block of the formula

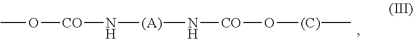

(A) is a residue of an aliphatic or aromatic diisocyanate linker,
(B) is a residue of a linear oligo- or polysiloxane containing alkanol end groups, and optionally further containing one or more aliphatic ether moieties, and
(C) is an aromatic oligo- or polysulfone block;
or a mixture of such oligo- or polyurethanes;
as an additive for the stabilization of a polymer membrane against oxidizing agents.

Membranes are commonly exposed to especially harsh conditions in the case of chemical backwash processes, which are explained below in more detail. In consequence, the present invention includes a filtration process, especially for water filtration, wherein a liquid permeates a polymer membrane, which process is characterized in that the membrane material comprising an oligo- or polyurethane of the formula I as shown above is subjected to chemically enhanced backwash;

as well as a process for the stabilization of a polymer membrane against the detrimental effects of chemical backwash, especially during chemical backwash stages of a water filtration process, which process comprises incorporation of an oligo- or polyurethane of the formula I as shown above into the membrane.

The blocks (X) and (Y) in formula I may be in statistical order or, again, in blocks; the usual procedure (see present examples) yields blocks (X) and (Y) in statistical order. Block (Y) is optional. The moieties (A), (B) and, if present, (C) may also comprise minor amounts of tri- or polyvalent residues, e.g. by including a minor quantity of a triisocyanate and/or tetraisocyanate into the preparation of the present oligo- or polyurethane. The resulting branched species share the advantageous properties of the present linear oligo- and polyurethanes, and are included by the present invention.

Preferred oligo- and polyurethane molecules of the invention contain at least one block (X) and at least one block (Y); preferred n ranging from 2 to 50, and preferred k ranging from 1 to 20. Preferably, m ranges from 1 to 50, especially from 2 to 50. The molecular weight (Mn) is preferably from the range 1500 to 100000, more preferably from the range 4000 to 25000. Most preferred compounds show a polydispersity ranging from 1.5 to 4.0.

Preferred (A) is a divalent residue selected from C₂-C₁₂alkylene and Ar, where Ar is as defined below.

Preferred (B) is a divalent residue of an oligo- or polysiloxane of the formula

-[Ak-O]_{q}-Ak-Si(R₂)-[O—Si(R₂)]ₚ—O—Si(R₂)-Ak-[O-Ak]_{q′}- (IV)

wherein Ak stands for C₂-C₄alkylene, R stands for C₁-C₄alkyl, and each of p, q and q′ independently is a number selected from the range 0-50.

Preferred (C) is a diphenyl sulfone monomer or linear oligomer or polymer block containing 1-50 moieties phenyl-SO₂-phenyl, and optionally further 1-50 further moieties Ar, which moieties are, in case of the oligomer or polymer, linked together by means selected from direct bonds and spacers “Sp”. The moiety (C) is typically an aromatic oligo- or polyarylether sulfone block.

Ar is selected from -Ph-Ph- and -Ph-“Sp”-Ph-.

Ph is phenyl or phenyl substituted by C₁-C₄alkyl.

Spacers “Sp” independently are —O— or C₁-C₃alkylene.

End groups in the oligomer or polymer (marked by asterisks * in formula I) mainly are mono-reacted constituents of the polyurethane (e.g. free OH from the diol component, or mono-reacted diisocyanate [—CO—NH-A-NCO], attached to (B) or (C) on the right side of formula I; or mono-reacted diol component HO—(B)— or HO—(C) attached on the left side of formula I). Chain termination may also be effected by including a certain amount (e.g. up to 20 mol-%) of monofunctional constituents, e.g. monoalcohols R′—(B)—OH or R′—(C)—OH where R′ is alkyl (such as C₁-C₄alkyl), Ar or especially H; R′ (appropriately attached to (B) or (C)) thus forming one or both end group(s). In accordance, the present oligo- and polyurethanes are essentially free of typical silane end groups like Si(R″)₃, where R″ is any of H, alkyl, alkoxy.

Due to their good compatibility, the present additives may be fully incorporated into other matrix polymers, or rigidly anchored in these matrices and enriched at the surface. Thus, the present block-copolymers may conveniently be used as an additive imparting antimicrobial and anti bioadhesion properties to polymeric articles and their surfaces, especially when incorporated into a membrane. The present copolymers contain one or more polysiloxane blocks as diol component (B), whose alkanol end groups are optionally extended by one or more ether moieties. Further moieties conveniently contained are aromatic polysulfone blocks (C) as second diol component. Linkage between the diol blocks is effected by urethane linkers (A) derived from aromatic or aliphatic diisocyanates.

A further important class of additives does not contain any polysulfone moieties (C), thus conforming to the formula V

—(X)ₙ— (V)

wherein n ranges from 2 to 100, especially from 2 to 50,
and where
(X) is a block of formula

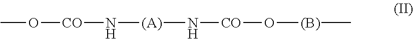

(A) is a residue of an aliphatic or aromatic diisocyanate linker,
(B) is a residue of a linear oligo- or polysiloxane, especially containing 3 or more Si atoms, and containing alkanol end groups, and optionally further containing one or more aliphatic ether moieties.

End groups in the sulfone-free oligo- or polyurethane mainly are mono-reacted constituents of the polyurethane (e.g. free OH from the diol component, or mono-reacted diisocyanate [—CO—NH-A-NCO]. In accordance, the present oligo- and polyurethanes are essentially free of typical silane end groups like Si(R″)₃, where R″ is any of H, alkyl, alkoxy.

Further constituents of the membrane generally comprise (as component b) one or more further organic polymers selected from the group consisting of polyvinyl pyrrolidone, polyvinyl acetates, cellulose acetates, polyacrylonitriles, polyamides, polyolefines, polyesters, polysulfones, polyethersulfones, polycarbonates, polyether ketones, sulfonated polyether ketones, sulfonated polyaryl ethers, polyamide sulfones, polyvinylidene fluorides, polyvinylchlorides, polystyrenes and polytetrafluorethylenes, copolymers thereof, and mixtures thereof; preferably selected from the group consisting of polysulfones, polyether-sulfones, polyvinylidene fluorides, polyamides, cellulose acetate and mixtures thereof.

Preferred meanings for (A) and (B) are as defined for copolymers of formula I above; specifically, the molecular weight (Mn) of the polyurethane is preferably from the range 1500 to 100000;

(A) preferably is a divalent residue selected from C₂-C₁₂alkylene and Ar;
(B) preferably is a divalent residue of an oligo- or polysiloxane of the formula

-[Ak-O]_{q}-Ak-Si(R₂)-[O—Si(R₂)]ₚ—O—Si(R₂)-Ak-[O-Ak]_{q′}- (IV)

wherein Ak stands for C₂-C₄alkylene, R stands for C₁-C₄alkyl, and each of q and q′ independently is a number selected from the range 0-50, and p ranges from 1 to 50, especially from 2 to 50;

### Ar is -Ph-Sp-Ph-;

Ph is phenyl or phenyl substituted by C₁-C₄alkyl; and
Sp independently is selected from direct bond, —O—, C₁-C₃alkylene.

The poly urethane reaction for the preparation of the present copolymers is analogous to the one commonly used to build up a broad variety of polymers such as soft and hard polyurethanes in multiple applications and use. Typically, the reaction is carried out in presence of aprotic none or less polar solvents and with the use of catalysts such as amines (imidazoles), tin organic compounds and others. Typical diols used are polyethlenglycols with varying molecular weight, poly-esterols or OH-terminated oligomers or even polymers. Thus, a great variety of copolymers are accessible regarding the use of technically available diisocyanates such as aliphatic diisocyanates (especially hexamethylenediisocyanate HDI), isophorone diisocyanate, aromatic methylendiphenyldiisocyanate (MDI) or 2,4-toluenediisocyanate (TDI). The variety of products is much more expandable, if mixtures of different diols are taken into account, resulting in fine-tuned polymeric structures with statistic linked diol blocks sequences. Therefore, the present urethane linked XnYm block copolymers are producible in a rational way with high variability to reach application requirements. As subject of the present invention, OH-terminated silicon based surfactants are useful as diol components in combination with diisocyanates.

Typical monomers for the preparation of the present polyurethanes are:

### A) Diisocyanates

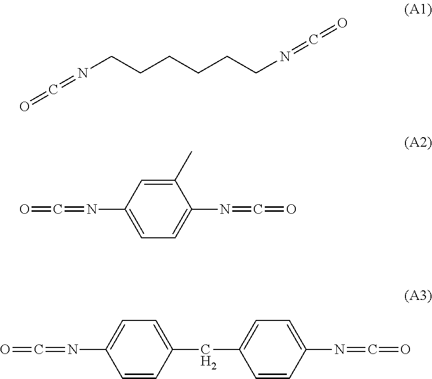 [SMILES: O=C=NCCCCCCN=C=O ; Cc1cc(N=C=O)ccc1N=C=O ; O=C=Nc1ccc(Cc2ccc(N=C=O)cc2)cc1]

### B) Dioles

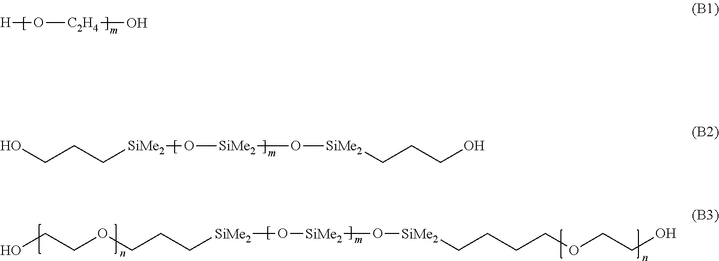

### C) Dioles

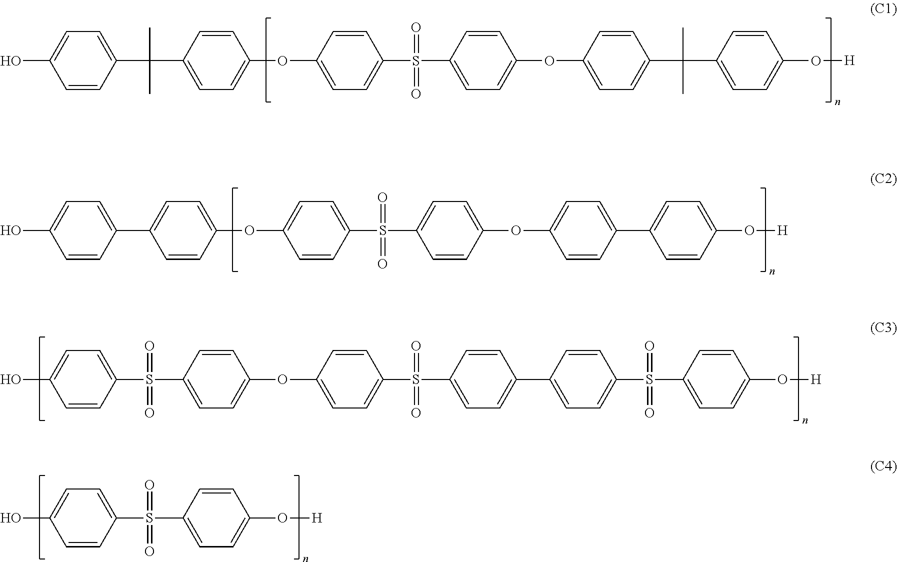

with n, m each ranging from 1 to 100.

### Polymer Compositions, Membrane Manufacturing and Processing

The present copolymers of formula I are preferably used as additives in polymer compositions, such as compositions for membranes, e.g. for gas separation membranes and especially for water processing membranes.

The water filtration membrane (semipermeable membrane) preferably consists essentially of a polymer composition comprising aforesaid oligo- or polyurethane in an amount of 0.1 to 25% by weight of the total polymer composition, especially in a homogenous phase or within the same phase enriched at the surface.

The process for preparing the semipermeable water treatment membrane of the invention generally comprises incorporation of the above oligo- or polyurethane, a further polymer as noted under component (b), and optionally further additives into the membrane material.

Polymer film membranes generally may be formed from the melt of a thermoplastic polymer, e.g. by extrusion, or from a polymer solution in a coating process or in a coagulation (phase inversion) process (such as SIPS described below). Typical polymers are polyvinyl pyrrolidone, vinyl acetates, cellulose acetates, polyacrylonitriles, polyamides, polyolefines, polyesters, polysulfones, polyethersulfones, polycarbonates, polyether ketones, sulfonated polyether ketones, sulfonated polyaryl ethers, polyamide sulfones, polyvinylidene fluorides, polyvinylchlorides, polystyrenes and polytetrafluorethylenes, copolymers thereof, and mixtures thereof, especially including poly ether sulfone.

Membranes formed from the polymer melt, or by mere coating or casting of the polymer solution, usually show an isotropic (symmetrical) cross section. In order to improve porosity and flux properties of such symmetrical membranes, U.S. Pat. No. 5,102,917 teaches mixing of large amounts of calcium carbonate particles into the polymer melt, with subsequent molding of the membrane by melt extrusion followed by leaching of the particles using HCl.

Membranes formed by phase inversion usually show an asymmetric structure comprising a thin (e.g. 10-50 nm), dense separation layer and a thick porous layer, the latter e.g. providing mechanical stability and efficient transport of the filtrate. These membranes thus clearly differ from membranes formed by lamination of 2 or more polymer films. Manufacturing of the present ultra filtration membranes often includes solvent induced phase separation (SIPS). The present copolymers are preferably employed as additives in this process.

Membranes of special technical importance of present invention are hollow fiber membranes, which may be prepared in analogy to methods described in EP-A-1198286.

In the SIPS process, the educt polymers (e.g. selected from polyvinyl pyrrolidone, vinyl acetates, cellulose acetates, polyacrylonitriles, polyamides, polyolefines, polyesters, polysulfones, polyethersulfones, polycarbonates, polyether ketones, sulfonated polyether ketones, sulfonated polyaryl ethers, polyamide sulfones, polyvinylidene fluorides, polyvinylchlorides, polystyrenes and polytetrafluorethylenes, copolymers thereof, and mixtures thereof; preferably selected from the group consisting of polysulfones, polyethersulfones, polyvinylidene fluorides, polyamides, cellulose acetate and mixtures thereof, especially including poly ether sulfone) are dissolved in a suitable solvent (e.g. N-methylpyrrolidone, dimethylacetamide or dimethylsulfoxide) together with the additive(s). In a next step, a porous polymeric membrane is formed under controlled conditions in a coagulation bath. In most cases, the coagulation bath contains water as coagulant, or the coagulation bath is an aqueous medium, wherein the matrix forming polymer is not soluble. The cloud point of the polymer is defined in the ideal ternary phase diagram. In a phase separation, a microscopic porous architecture is then obtained, and water soluble components (including polymeric additives) are finally found in the aqueous phase.

In case that the polymeric additive is simultaneously compatible with the coagulant and the matrix polymer(s), segregation on the surface results. With the surface segregation, an enrichment of the additive can be achieved. The membrane surface thus offers new (hydrophilic or hydrophobic) properties compared to the primarily matrix-forming polymer, the phase separation induced enrichment of the additive of the invention leading to membranes showing improved chemical resistance.

An important property of the novel surface modifying additive is the formation of a dense coverage combined with a strong anchoring effect to the polymeric matrix. In many cases, a surface structure is obtained by micro-structured self-assembling monolayers (SAM).

In addition, the present copolymers also combine structural elements, which encourage detachment of fouling. These copolymers are especially useful as a blending additive, since they contain an antifouling segment and an anchor, the combination of which is especially useful for membrane applications; the silicone moiety further is a good “sticking polymer” to polysulfone, thus providing structural stability and contributing to the low leaching properties.

The present copolymers combine low energy segments and hydrophilic segments. Phenomenologically, these segments reassemble to form nano-scaled structures in the topography of the membranes surface. In case of simultaneous self assembling of the copolymers during the SIPS process, the membrane surfaces are covered by substructures leading to reduced fouling properties of the membrane either by added topographic (relief and/or area dimension) or surface energy structuring moieties (by electrostatic interaction with the ambient media).

Additional antifouling properties of the present polymer compositions, especially of the membranes, may be enhanced by further incorporation of one or more antimicrobial or bacteriostatic agents into the composition. A preferred agent is an oligodynamic metal, especially silver in ionic and/or metallic form. Optionally, the silver component may be accompanied by zinc oxide as co-component (silver composites such as disclosed in WO 11/023584). Useful silver components include silver colloids, silver glass, silver zeolites, silver salts, elemental silver in form of powder or microparticles or nanoparticles or clusters. An advantageous method of preparing an antimicrobial membrane includes in situ formation of elemental silver particles in the casting solution containing one or more (co)polymers of the present polymer composition in dissolved form. Elemental silver particles, especially those incorporated into semipermeable membranes and/or polymer matrices close to the final article's surface, may be transformed into silver halogenide particles such as AgCl, AgBr, AgI, e.g. by treatment with a hypohalogenide solution (e.g. of NaOCl).

A typical process for the preparation of membranes may comprise the following steps:
1. Dissolving matrix polymers for a membrane's dope in a suitable solvent, typically NMP, DMA, DMF, DMSO or mixtures of them.
2. Adding pore forming polymeric additives such as PVP, PEG, sulfonated PESU or mixtures of them.
3. Heating the mixtures until a viscous solution is obtained; typically temperatures are from the range 5-250° C., preferred 25-150° C., mostly preferred 60-90° C.
4. Adding the present silicone-polyurethane additive of the formula I to the dope at 5-250° C., preferred 25-150° C., and mostly preferred 60-90° C. Optionally other additives may be added in the same step.
5. Stirring of the solution/suspension until a mixture is formed within 1-15 h, typically the homogenization is finalized within 2 h.
6. Casting, or extruding by wet spinning, the membrane dope in a coagulation bath to obtain a membrane structure. Optionally, the casting may be outlined using a polymeric support (non-woven) for stabilizing the membrane structure mechanically.
7. Optional analysis of the membrane.

The present membrane may further comprise hydrophilicity enhancing additives, such as those disclosed in WO 02/042530.

The present membrane may further contain polysiloxane tensides such as disclosed in WO 11/110441.

The present membrane may be uncoated, or contain a coating layer, such as the one described in the international application PCT/IB2013/050794.

The weight ratio of any further additives or coating materials to the particles within the present membrane is preferably in the range of 5:95 to 95:5.

The present membranes are typically combined to form filtration modules, often comprising numerous cylindrical (hollow fiber) membranes. Such modules are subjected to certain cleaning operations as described below, especially where modules are used for water filtration.

### Membrane Cleaning Operations

In continuous processes using polymer filtration membranes, such as processes for ultrafiltration or reverse osmosis, periods of operation are commonly interrupted by 2 different types of cleaning operations: The first, more frequent one is a mere washing stage removing impurities on the feed water side commonly recalled as back flush or back washing step (BW). Generally after a longer term of operation, a step of chemical cleaning (often recalled as chemically enhanced backwash, CEB) is required in order to restore the membrane's permeability.

It is generally important that the membrane unit is equipped with an efficient cleaning system allowing periodical membrane regeneration, especially in dead end filtration systems using ultrafiltration (UF) or microfiltration (MF) membranes, e.g. for water and wastewater applications. As permeate is often used for cleaning operations, the productivity of the process sensitively depends on the frequency of these steps, which should be run under optimal conditions to ensure the optimal membrane regeneration and the highest possible permeate production per m² of membrane area. Generally, there are two types of cleaning operations:
Back washing using water (BW; the water may be permeate, fresh water or, in some cases, feed water)
Washing with diluted chemicals dissolved e.g. in permeate, known as chemical enhanced backwash (CEB)

In order to carry out both operations, various types of equipment can be applied.

### Back Wash (BW):

Back wash, e.g. using permeate only, generally has to be repeated more frequently than CEB. A BW step is usually carried out
after pre-defined time intervals (typically, the back wash frequency can vary between 5 minutes and several hours, depending on the feed water quality); or
when the trans-membrane pressure (TMP) reaches its pre-defined value. This option allows a more flexible application of back wash, which may be adapted to feed water quality and thus prevent unnecessary losses of permeate.

The goals of back wash are mechanical removal of particles and deposit layers from the membrane surface and pores in order to increase the effective filtration area of the membrane. BW is widely used not only in water and wastewater UF and MF applications, but also in all kind of other applications in cross flow as well as in dead end systems. In a typical back wash operation,
a first rinsing (e.g. by opening the retentate path during the active feed flow) step is performed for a short period of time (e.g. 10 to 60 seconds);
the flow rate of permeate during the back wash is much higher as the filtration rate. For dead end filtration it should be higher as 200 l/m²*h (much higher flow rate is advantageous, but the mechanical membrane stability has to be considered);
the amount of back wash per m² is preferably at least 2 l/m² per BW. The optimum typically depends on the feed water/wastewater quality, and is a compromise between the optimal membrane regeneration and the highest possible permeate yield.

To complete the back wash, higher pressure in permeate than in the feed has to be established in order to induce a high flow rate in reverse direction. This is often realized using a pump, or gas pressure which is set on the permeate. Typically during BW, the feed inlet is closed and the retentate outlet is opened; a permeate buffer tank is advantageous.

### Chemical Back Washing (Chemically Enhanced Backwash, CEB):

In many applications, mere back washing with permeate does not solve the problem of membrane fouling for an extended period of operation. As a consequence, the initial TMP increases after each BW, and an additional measure is necessary for full membrane regeneration. In these processes, maintenance steps with addition of chemicals are thus carried out in certain intervals after operation in order to remove suspended solids from the membrane surface, membrane pores or other parts of the filter module. In that case, chemical back washing or off line chemical washing is applied. Typically, these chemicals are acids, bases and/or oxidants. CEB can be done without stopping the filtration procedure, resulting in a duration time much shorter and a chemical demand much lower than in the case of off line chemical washing.

CEB is initiated, when membrane regeneration with BW is no longer effective and the TMP is too high. The goal of CEB is to remove the most of fouling components from the membrane surface and from the pores and to bring the TMP back to the initial value. CEB steps can be run after fixed intervals or advantageously when the TMP reaches a certain value. Depending on the feed quality, typical periods between CEB's may vary between 3 and 24 h or even longer.

Membrane fouling is a very complex process, which is not yet fully understood. Most of the deposits consist of material not belonging to one single chemical “class” but, depending on the feed water conditions such as temperature, time of the year or intensity of rainfall, showing strong variations of its composition. For example, such fouling deposit may contain major components of:
Mechanical particles such as sand, clay, Si-compounds etc.
Scaling products from Ca-, Mg-, Ba-sulfate or carbonate
Iron precipitations
Bacteria and bacteria films
Algae and its biofilms
Polysaccharides, humic acids and other organics
Metabolism products from bacteria, algae and other microorganisms

The main goal of CEB is to keep the growth of such fouling deposits on a minimal level, while keeping frequency and duration of CEB short enough to minimize use of chemicals and system down times. Most of the fouling deposits can be removed using acid, base and/or an oxidizing agent; typically diluted H₂SO₄, HCl, HNO₃, NaOH, NaOCl etc. The regeneration effect of the CEB depends not only on its frequency, the concentration of cleaning agents but also on the proper sequence of the used chemicals. Often used washing agents are:
Sulfuric acid, typically in a concentration of 0.015 N or higher, so that the pH of the cleaning liquid ranges between 0.5 and 2
Other inorganic acid solutions, typically of similar pH range
Base solution, mostly NaOH as the cheapest base, typically in a concentration of 0.03 N or higher, so that the pH of cleaning solution ranges between 10.5 and 12.5
Oxidizing agents such as NaOCl, typically in a concentration between 3 and 50 ppm in alkaline solution. Other oxidizing chemicals such as H₂O₂ can also be used. In order to contact the membranes with the cleaning chemicals, a separate chemical back wash system is usually applied, especially to avoid permeate contamination and/or to allow separate cleaning of different membrane sections. It may contain:
Dosing equipment of concentrated chemicals to the back wash permeate, such as dosing pumps, flow meters, pressure transmitters
Mixing device like for instance Venturi injector, pump injector or static mixer
pH sensor in feed for pH control of cleaning solution
pH sensor in outlet to ensure the complete removal of chemicals from the system
Separate piping system for removal of one chemical before the second one is applied.

In case of CEB, flow through the membrane is not as essential as in case of BW. The main point is that the CEB solution completely fills the modules to ensure optimal conditions for CEB in the whole membrane area.

In a typical CEB cleaning step, once one of the cleaning chemicals is filled into the module, the dosing is stopped and the static washing is started. The optimal washing time depends on the origin and composition of the deposits and the chemicals used, and often varies from about 10 to 60 minutes.

For example, a CEB sequence for optimal membrane regeneration may be as follows:
a) Rinsing of the modules using feed by opened retentate path (10-30 seconds);
b) NaOH washing, typically by filling NaOH solution into the module and steeping it for about 30-60 minutes;
c) ejection of NaOH solution, controlled, for instance, by a pH sensor;
d) NaOCl washing (or washing with any other oxidizing agent), e.g. by filling NaOCl solution into the module and steeping it for about 30-60 minutes (as an alternative, this step d may be combined with aforesaid step b);
e) ejection of NaOCl solution (or solution of the oxidizing agent), controlled, for instance, by a pH or redox sensor (alternatively to be combined with step c);
f) washing with acid, typically sulphuric acid, e.g. by filling H₂SO₄ solution into the module and steeping it for about 30-60 minutes;
g) ejection of acid solution, controlled, for instance, by a pH sensor;
h) restart of the permeate production procedure.

CEB is advantageously started, when the TMP increases above a certain value, or after a predefined operation time, for instance every 8 hrs.

A further application is a continuous use of oxidizing agents, for example as a continuous feed chlorination such as commonly used for swimming pools or in process control.

The following examples illustrate the invention. Unless otherwise stated, room temperature (r.t.) denotes an ambient temperature of 20-25° C.; molecular weight data (such as Mw, Mn) are as determined by gel permeation chromatography; and water contact angle (WCA) measurements are performed according to the static sessile drop method.

Abbreviations used in the examples and elsewhere:
L litre

### NMP N-methylpyrrolidone

### PD Polydispersity

### PEG Polyethyleneglycol

### PESU Poylethersulfone

### PVP Polyvinylpyrrolidone

### THF Tetrahydrofurane

w %, wt % percent by weight
micron micrometer

### Components Used in the Examples:

### A) Diisocyanates

HDI (1,6-Hexamethylene diisocyanate); TDI (2,4-Toluenediisocyanate); and MDI (Diphenylmethane-4,4′-diisocyanate) are commercial products from Aldrich.

### B) Diol 1

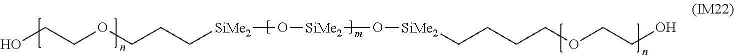

Poly dimethylsiloxane-b-polyethyleneoxide: m=15 and n=10; available from Wacker, Germany (IM 22®).

### C) Diol 2

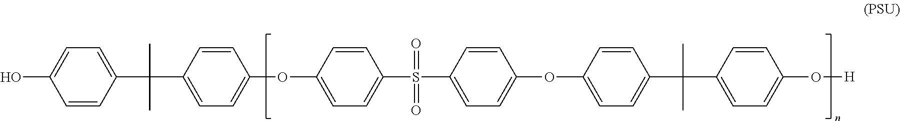

Mn=2-3 kDa, Mw=4-5 kDa; OH number: 0.98-1.01 mEq/g

### D) Further Polymers and Solvents:

THF and NMP are commercial products from Aldrich. Polyvinylpyrrolidone: Luvitec® PVP 40 K and Luvitec® PVP 90 K are commercial products from BASF SE, Germany. Polyethersulfone: Ultrason® E 3010P and Ultrason® E 6020P are commercial products from BASF SE, Germany.

### EXAMPLE 1

### General Preparation of the Siloxane-Block-Polyurethane

### Instruments: 250 ml Erlenmeyer Glass Tube, Magnetic Stirrer, Heat Plate, Condenser, Internal Thermometer

Diol components are mixed in 120 ml of tetrahydrofurane (THF) at 25° C. According to the sum of the OH-numbers of the diol components, the diisocyanate component is added in one dosage. Solid diisocyanate components are added as a solution in 30 ml of THF. After stirring the mixture for 5 minutes, the catalysts (1,8-diazabicyclo[5.4.0]-undec-7-ene (DBU): 0.1 g; and dibutyl tin dilaurate: 0.1 g) are added. The well observable NCO-absorption vibration at 2325 cm⁻¹ is used for monitoring the progress of the reaction. The reaction mixture is stirred for 4 hours at 40° C. and subsequently for 15 hours at 25° C. Then, all volatile components are evaporated using a rotary evaporator and high vacuum pump. The crude polymeric compounds are characterized by elemental analysis, ¹H-NMR and gel-permeation chromatography. The following Tables 1 and 2 show the amounts of reactants used and the characterization of the polymers obtained.

TABLE 1
Composition of copolymers (amounts [g]
refer to component in column left)

| Sample | Diol 1 | [g] | Diol 2 | [g] | Diisoc. | [g] |
|---|---|---|---|---|---|---|
| A | IM22 | 20 | PSU | 40 | HDI | 4.0 |
| B | IM22 | 10 | PSU | 40 | HDI | 3.1 |
| C | IM22 | 35 | PSU | — | HDI | 2.92 |
| D | IM22 | 10 | PSU | 40 | MDI | 5.95 |
| E | IM22 | 15 | PSU | 30 | MDI | 5.38 |
| F | IM22 | 35 | PSU | — | MDI | 4.34 |

### Characterizations of the Polyurethane Block Copolymers:

Gel permeation chromatography (GPC) in tetrahydrofurane and polystyrene as reference and elementary analysis (EA). Results are shown in table 2.

TABLE 2
Copolymer characteristics

| Sample | GPC (Da) | | | | |
|---|---|---|---|---|---|
| No. | Mw | Mn | Mp | PD | Elemental Analysis |
| A | 9030 | 3810 | 7290 | 2.37 | C: 63%; H: 6.58%; N: 1.37%; O: 16.8%; |
| | | | | | S: 3.54%; Si: 5.3% |
| B | 10160 | 3450 | 9110 | 2.94 | C: 66.3%; H: 5.64%; N: 1.38%; O: 15.6%; |
| | | | | | S: 4.15%; Si: 3.3% |
| C | 9700 | 4050 | 9160 | 2.39 | C: 46.7%; H: 7.7%; N: 1.14%; O: 25.8%; |
| | | | | | Si: 18.7% |
| D | 22100 | 8640 | 20640 | 2.56 | C: 67.8%; H: 6.08%; N: 1.59%; O 15.6%; |
| | | | | | S: 3.94%; Si: 3.2% |
| E | 18630 | 4470 | 13370 | 4.17 | C: 64.9%; H: 6.8; N: 1.48; O: 15.4%; S: |
| | | | | | 3.7%; Si: 4.3% |
| F | 17800 | 7060 | 14580 | 2.55 | C: 43.5%; H: 8.12%; N: 1.52%; O: |
| | | | | | 26.4%; Si: 17.7% |

These additives are used at ca. 5 wt % based on PESU to prepare cylindrical hollow fiber and flat sheet membranes as reported in Example 3 further below.

### EXAMPLE 2

### Preparation of PESU Cylindrical Membranes (Reference Membrane G)

A polymer solution of 20% polyethersulfone (PESU, Ultrason® E 3010P), 9% polyvinylpyrrolidone (PVP, Luvitec® K90), 10% of glycerine and 61% N-methylpyrrolidone (NMP) is extruded through an extrusion nozzle having a diameter of 4.0 mm and 7 needles of 0.9 mm. A solution of 40% NMP in 60% water is injected through the needles, as a result of which channels are formed in the polymer solution. The diameter of the channels is 0.9 mm, the total diameter is 4.0 mm. The extrusion speed is 7 m/min, the coagulation bath has a temperature of 80° C.; the length of the path through water vapour is 20 cm. After rinsing and removal of the superfluous PVP, a membrane is obtained having a flux of 800-1400 l/m/h/bar (in relation to the channels). The cut-off value is 125000 Da. The pores in the outer surface are in the range of 1-2 micron.

### EXAMPLE 3

### Preparation of PESU Cylindrical Membranes Functionalized with Polyurethane Block Copolymer Based on Polysiloxane (Invention)

Membranes are prepared in accordance with the procedure described in Example 2, but further adding 5.0% by weight, based on polyethersulfone, of a copolymer of Example 1 to the polymers solution. After rinsing and removal of the superfluous PVP, membranes are obtained having a flux of 1000-1400 l/m/h/bar (in relation to the channels). The cut-off value is 125000 Da. The pores in the outer surface are in the range of 1-2 micron.

### EXAMPLE 4

### Characterization of Membranes

Evaluation of the distribution of the additive described in Example 1 between membrane bulk, outer and inner surfaces is performed to investigate the surface enrichment behaviour of these polyurethane block polysiloxane copolymers when used as additive in polymeric membrane materials. Representative examples are reported below in Table 3.

Enrichment factor is calculated as follows:

EF (Enrichment Factor)=Si wt % at surface/Si wt % in bulk.

Si wt % in the bulk is analysed by ICP-MS (inductively coupled plasma mass spectrometry) for the entire membrane sample: double measurements on 0.5 g polymer material.
Si wt % on inner or outer surfaces is evaluated by XPS (X-Ray Photoelectron spectroscopy depth of analysis 2-10 nm), over 3 points of 0.5 mm² each.

TABLE 3
Membrane characteristics (enrichment of Si-Additive on surfaces)

| | | | Si wt % | Si wt % | EF (Si) | EF (Si) |
|---|---|---|---|---|---|---|
| | Additive | Si wt % | Outer | Inner | Outer | Inner Sur- |
| Membrane | (5 wt %) | in Bulk | Surface | Surface | Surface | face |
| G | — | — | — | — | — | — |
| (Reference) | | | | | | |
| H | D | 0.12% | 1.7% | 0.5% | 14 | 4 |
| I | C | 0.47% | 4.2% | 1.4% | 9 | 3 |

### EXAMPLE 5

### Properties of Cylindrical Membranes after Exposure to NaOCl Solution

Cylindrical membranes of Examples 2 and 3 are tested for NaOCl chemical stability. Tubular capillaries, 5 cm long, after washing in 500 mL of H₂O for 30 minutes, are placed wet in a 500 mL closed flask filled with a 500 ppm (calculated as total free chlorine) aqueous NaOCl solution at room temperature. HCl 0.1 N is used to adjust to pH=6.

The NaOCl solution is replaced every 48 hours and the test is run for 4 days. After this time, membranes are removed from NaOCl solution and washed several times with water and 0.5% NaHSO₃(aq). Then, membranes are conditioned at 50% humidity at r.t for 48 h before evaluating their mechanical properties and GPC variation.

Reduction of mechanical properties and molecular weight (GPC: Mw and Mn) due to NaOCl exposure is related to membrane polymer degradation. Results are reported below in Tables 4 and 5.

TABLE 4
Reduction of mechanical properties for cylindrical membranes exposed
for 4 days at NaOCl due to chemical degradation. Data as average of
5 sample measurements. Test method: ISO527-1; Probe Type: Typ 5A.
Force probe: 100N; Speed: 50 mm/min.

| | | Elongation@break | | Tensile Strength | |
|---|---|---|---|---|---|
| | | (%) | | (MPa) | |
| | | | After | | After |
| Membrane | Additive | Start | 4 days | Start | 4 days |
| G | none | 52 | 5.0 (−90%) | 2.92 | 2.29 (−21.5%) |
| (Reference) | | | | | |
| H | D | 52 | 9.5 (−82%) | 2.76 | 2.55 (−8%) |
| I | C | 60 | 15 (−75%) | 2.93 | 2.77 (−5.5%) |

TABLE 5
Reduction of molecular weight for cylindrical membranes exposed for
4 days at NaOCl due to chemical degradation. GPC done in
Dimethylacetamide + 0.5% LiBr. Calibration: polymethylmethacrylate

| | | | | Mn (Da) | |
|---|---|---|---|---|---|
| | Addi- | Mw (Da) | | | After 4 |
| Membrane | tive | Start | After 4 days | Start | days |
| G | None | 55520 | 43570 (−21.5%) | 14920 | 7780 (−48%) |
| (Reference) | | | | | |
| H | D | 53150 | 44210 (−17%) | 11400 | 7820 (−31%) |
| I | C | 52440 | 46370 (−12%) | 11770 | 8280 (−30%) |

Tables 4 and 5 clearly show that cylindrical membranes functionalised with the current additive (i.e. the polyurethane block copolymer based on polysiloxane as of Example 1) have a better chlorine resistance, which is reflected in a lower reduction of mechanical properties (both Tensile and Elongation) as well as reduction of molecular weight when compared with standard membrane.

### EXAMPLE 6

### Preparation of PESU Flat Sheet Membranes (Reference Membrane L)

Into a three neck flask equipped with a magnetic stirrer there is added 80 ml of N-methylpyrrolidone (NMP), 5 g of polyvinylpyrrolidone (PVP, Luvitec® K40) and 15 g of polyethersulfone (PESU, Ultrason® E 6020P). The mixture is heated under gentle stirring at 60° C. until a homogeneous clear viscous solution is obtained. The solution is degassed overnight at room temperature. After that the membrane solution is reheated at 60° C. for 2 hours and casted onto a glass plate with a casting knife (300 microns) at 40° C. The membrane film is allowed to rest for 30 seconds before immersion in a water bath at 25° C. for 10 minutes.

After rinsing and removal of excess PVP, a flat sheet continuous film with micro structural characteristics of UF membranes having dimension of at least 10×15 cm size is obtained. The membrane presents a top thin skin layer (1-3 microns) and a porous layer underneath (thickness: 100-150 microns).

### EXAMPLE 7

### PESU Flat Sheet Membranes Functionalised with Polyurethane Block Copolymer Based on Polysiloxane (Invention)

Polyurethane block polysiloxane functionalized membranes are casted in the way as reported in Example 5, but with further addition of copolymers as prepared in Example 1 at a concentration of 5.0 wt % based on polyethersulfone to the viscous solution. After rinsing and removal of PVP, a flat sheet continuous film with micro structural characteristics of UF membranes having dimension of at least 10×15 cm size is obtained. The membrane presents a top thin skin layer (1-3 microns) and a porous layer underneath (thickness: 100-150 microns).

### EXAMPLE 8

### Characterization of Flat Sheet Membranes

In the same way as for the cylindrical membranes, the present additive (polyurethane block polysiloxane copolymer as of example 1) shows the ability to self-enrich on membrane surface.

Evaluation of additive's distribution between membrane bulk and top flat sheet surface (surface not in contact with glass plate during casting) is performed in the same way as described in Example 4 for the cylindrical membranes. Representative examples for the enrichment achieved are reported below in Table 6.

TABLE 6
Additive enrichment on surface of flat sheet membrane, based on
Silicon. Si concentrations are given in % by weight.

| | | | Si wt % | EF (Si) |
|---|---|---|---|---|
| | | Si wt % | Top | Top |
| Membrane | Additive | in Bulk | Surface | Surface |
| L | — | — | — | — |
| (Reference) | | | | |
| M | F | 0.83% | 7.6% | 8.5 |

### EXAMPLE 9

### Mechanical Properties and GPC Evaluation of Flat Sheet Membranes after Exposure to Concentrated NaOCl Solution

Flat sheet membranes of examples 6 and 7 are tested for NaOCl chemical stability. Flat sheets, 10×12 cm long, previously washed in 500 mL of water for 30 minutes, are wet in 500 mL closed flask with a 1000 ppm (calculated as total free chlorine) aqueous NaOCl solution at room temperature. HCl 0.1 N is used to adjust to pH=7. NaOCl solution is replaced every 24 h and the test is run for 3 days. After this time, membranes are removed from the NaOCl solution and washed several times with 0.5% NaHSO₃(aq) and H₂O. Then, membranes are conditioned at 50% humidity at r.t for 48 h before evaluating their mechanical properties and GPC variation.

Dumbbell-shaped probes 7.5 cm long and 1.3/0.5 cm wide are cut out and used to evaluate membrane mechanical properties.

Reduction of mechanical properties and molecular weight (GPC; Mw and Mn) due to NaOCl exposure is related to membrane polymer degradation. Results are reported in Tables 7 and 8.

TABLE 7
Reduction of mechanical properties for flat sheet membranes exposed for 3
days at NaOCl due to chemical degradation. Data as average of 5 sample
measurements. Test method: ISO527-1; Probe Type: Typ 5A. Force probe:
100N; Speed: 50 mm/min.

| | | Elongation@break | | Tensile Strenght | |
|---|---|---|---|---|---|
| | | (%) | | (MPa) | |
| Flat sheet | | | After | | After |
| Membrane | Additive | Start | 3 days | Start | 3 days |
| L | none | 22 | 11.5 (−48%) | 2.78 | 2.41 (−13%) |
| (Reference) | | | | | |
| M | F | 23 | 15 (−35%) | 2.40 | 2.20 (−8%) |

TABLE 8
Reduction of molecular weight for flat sheet membranes exposed for
3 days at NaOCl due to chemical degradation. GPC done in
Dimethylacetamide + 0.5% LiBr. Calibration: polymethylmethacrylate

| Flat Sheet | Addi- | Mw (Da) | | Mn (Da) | |
|---|---|---|---|---|---|
| Membrane | tive | Start | After 3 days | Start | After 3 days |
| L | None | 55580 | 47900 (−14%) | 17300 | 14000 (−19%) |
| (Reference) | | | | | |
| M | F | 54950 | 52550 (−4.5%) | 16100 | 14900 (−7.5%) |

Tables 7 and 8 clearly indicate that also for flat sheet membranes resistance to high chlorine concentration exposure is extended for membranes functionalised with polyurethane block copolymer based on polysiloxane. This higher tolerance for chlorine is translated into better retention of mechanical properties (both Tensile and Elongation) as well as membrane molecular weight if compared with standard membrane.

### EXAMPLE 10

### Hollow Fibre Modules in Long Term Filtration Test

Membranes produced as described in Example 2 (reference) or 3 (containing the polysiloxane additive D of example 1) are used in cross flow filtration modules of filtration area 0.35 m² and 50 cm length for river water filtration under industrial operational conditions and continuous operation. Filtration periods (FP) are interrupted by permeate back flush (BW) every 0.5 h as indicated in the below Table 9, and by chemical cleaning (CEB) after periods indicated in the below Table 9. Chemical cleaning steps (CEB) are performed as soon as the trans membrane pressure (TMP) reaches 0.7 bar by soaking the module for 30 minutes in aqueous 0.05 N NaOH containing 30 ppm of NaOCl, followed by soaking with 0.03 N H₂SO₄ for 30 minutes and rinsing; each CEB is performed within 68 minutes.

Table 9 shows the performance of membranes, which have been run for 640 hours with identical flux rates (85.7 kg/m²/h of permeate flux during FP, and 228 kg/m²/h of permeate flux during BW). The subsequent testing period is 194 hours, detecting the CEB frequency, filtration efficiency (filtrate yield per day of operation) and capacity increase compared to the module containing the reference membrane.

TABLE 9
Membrane efficiency after 640 h of operation

| | Periods | | Efficiency | |
|---|---|---|---|---|
| | Between | BW | Yield | Capacity Increase |
| Module | CEBs | every | (Kg/m²/d) | (%) |
| Reference | 8.8 h | 0.5 h | 1543 | — |
| Prepared with 5 wt % | 11.5 h | 0.5 h | 1603 | 4.0 |
| of polysiloxane | | | | |
| additive (D) | | | | |

Table 9 shows that membranes functionalized with the polysiloxane additive require significantly less cleaning (BW as well as chemical back wash) while being able to provide higher filtration performance relative to non-functionalized membranes.

### EXAMPLE 11

### Hollow Fiber Modules in Long Term Filtration Test

Membranes are produced and run in cross flow filtration modules as described in example 10. Filtration periods (FP) are interrupted by clean water back flush (BW) every 0.5 h, and by chemical cleaning (CEB) after periods indicated in the below Table B. Chemical cleaning steps (CEB) are performed as soon as the trans membrane pressure (TMP) reaches 0.7 bar by soaking the module for 30 minutes in aqueous 0.05 N NaOH containing 30 ppm of NaOCl, followed by soaking with 0.03 N H₂SO₄ for 30 minutes and rinsing; each CEB is performed within 68 minutes. Table 10 shows the performance of membranes, which have been run for 800 hours with flux rates as indicated in Table B (BW flux identically 228 kg/m²/h in all cases). The subsequent testing period is 110 hours, detecting the CEB frequency, filtration efficiency (filtrate yield per day of operation) and capacity increase compared to the module containing the reference membrane.

TABLE 10
Membrane efficiency after 800 h of operation

| | Flux | Period | | Efficiency | |
|---|---|---|---|---|---|
| | (Kg/m²/h) | Between | BW | Yield | Capacity |
| Module | Permeate | CEBs | every | (Kg/m²/d) | Increase (%) |
| Reference | 85.7 | 14.5 h | 0.5 h | 1642 | / |
| Prepared | 100 | 14.3 h | 0.5 h | 1952 | 18.9 |
| with 5 wt % of | | | | | |
| polysiloxane | | | | | |
| additive (D) | | | | | |

Table 10 shows that the functionalized membrane can be operated at higher permeate filtration flow than the standard membrane, with approximately same frequency of cleaning, leading to strongly increased permeate yield.

A test of the membrane's retention performance after 800 hours of operation and using PVP of 50 kDa as a model substance (1% PVP solution, TMP=0.5 bar, room temperature, cross flow condition) shows no significant difference between the membranes tested.

1. An oligo- or polyurethane of the formula I: 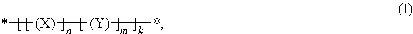
wherein:
k and n independently are numbers from 1 to 100;
m ranges from 0-100;
(X) is a block of formula: 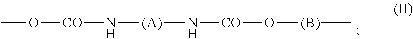
(Y) is a block of the formula: 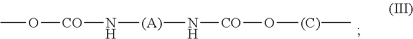
(A) is a residue of an aliphatic or aromatic diisocyanate linker;
(B) is a residue of a linear oligo- or polysiloxane comprising alkanol end groups, and optionally further comprising one or more aliphatic ether moieties; and
(C) is an aromatic oligo- or polysulfone block,
or a mixture of such oligo- or polyurethanes,
said oligo- or polyurethane being adapted to function as a stabilizer for a polymer membrane against detrimental effects of acids, bases, oxidizing agents, or mixtures thereof.

2. A process for stabilizing a polymer membrane, the process comprising contacting the polymer membrane with the oligo- or polyurethane of claim 1, wherein the polymer membrane is a water filtration membrane, and comprises the oligo- or polyurethane of the formula I as an additive.

3. The process of claim 2, wherein the stabilization of the polymer membrane occurs in the presence of against an aqueous solution of at least one oxidizing agent selected from the group consisting of H₂O₂, ozone, a peracid, ClO₂, KMnO₄, Cl₂, chlorate, perchlorate, and hypochlorite.

4. The process of claim 2, wherein the stabilization of a water filtration membrane occurs to prevent degradation of the polymer membrane during a chemical backwash or a cleaning processes.

5. The process of claim 2, wherein the polymer membrane comprises at least one polymer selected from the group consisting of a polyvinyl pyrrolidone, a vinyl acetate, a cellulose acetate, a polyacrylonitrile, a polyamide, a polyolefin, a polyester, a polysulfone, a polyethersulfone, a polycarbonate, a polyether ketone, a sulfonated polyether ketone, a sulfonated polyaryl ether, a polyamide sulfone, a polyvinylidene fluoride, a polyvinylchloride, a polystyrene and a polytetrafluorethylene, copolymers thereof, and mixtures thereof.

6. The oligo- or polyurethane of claim 1, wherein:
the oligo- or polyurethane of the formula I is of the molecular weight (Mn) from the range 1500 to 100000;
n and m range from the range 1 to 50; and
k is from range 1 to 20.

7. The oligo- or polyurethane of claim 1, wherein:
(A) is a divalent residue selected from C₂-C₁₂alkylene and Ar;
(B) is a divalent residue of an oligo- or polysiloxane of the formula:
-[Ak-O]_{q}-Ak-Si(R₂)-[O—Si(R₂)]ₚ—O—Si(R₂)-Ak-[O-Ak]_{q′}- (IV);
Ak represents a C₂-C₄alkylene;
R represents a C₁-C₄alkyl;
p, q and q′ independently represent a number ranging from 0-50;
(C) is a diphenyl sulfone monomer or linear oligomer or polymer block comprising 1-50 moieties phenyl-SO₂-phenyl, and optionally further 1-50 further moieties Ar, which moieties are, in case of the oligomer or polymer, linked together by spacers Sp;
Ar is -Ph-Sp-Ph-;
Ph is phenyl or phenyl substituted by C₁-C₄alkyl; and
Sp independently represents a direct bond, —O—, or a C₁-C₃alkylene.

8. The process of claim 2, wherein the polymer membrane comprises the oligo- or polyurethane of formula I in an amount of 0.1 to 25% by weight, relative to a total weight of the polymer membrane.

9. The process of claim 2, wherein the membrane is an asymmetric polymer membrane obtained from a polymer solution in a coating process or in a phase inversion process, in which the oligo- or polyurethane of formula I has been added to the polymer solution.

10. A filtration process, comprising passing a liquid through a polymer membrane comprising the oligo- or polyurethane of claim 1, wherein a chemically enhanced backwash of the polymer membrane occurs with a solution of an oxidizing agent.

11. A process for maintaining or cleaning a filtration module or plant comprising at least one organic polymer filtration membrane comprising the oligo- or polyurethane of claim 1, the process comprising contacting the filtration membrane with an aqueous solution of an oxidizing agent.

12. The process of claim 11, which is adapted for maintaining or cleaning a water filtration module.

13. The process of claim 11, wherein the filtration membrane is a asymmetric polymer membrane obtained by solvent induced phase separation.

14. The process of claim 2, wherein the water filtration membrane is adapted for microfiltration, ultrafiltration, or reverse osmosis.

15. A membrane module, comprising the oligo- or polyurethane of claim 1.
